(19) United States
(12) Patent Application Publication
(10) Pub. No.: US 2022/0066833 A1
(43) Pub. Date: Mar. 3, 2022

(54) Device for a Vehicle for Externally Transferring Computing Processes

(71) Applicant: Volkswagen Aktiengesellschaft, Wolfsburg (DE)

(72) Inventors: Sarah Strygulec, Wuppertal (DE); Bianca Nowak, Castrop-Rauxel (DE)

(73) Assignee: Volkswagen Aktiengesellschaft, Wolfsburg (DE)

(21) Appl. No.: 17/414,760

(22) PCT Filed: Dec. 17, 2019
(86) PCT No.: PCT/EP2019/085612

§ 371 Date: Jun. 16, 2021

(30) Foreign Application Priority Data
Dec. 20, 2018 (DE) 10 2018 009 903.3

(51) Int. Cl. G06F 9/50; H04W 4/46; G06F 16/29

(52) U.S. Cl. CPC G06F 9/5027; H04W 4/46; H04W 84/18; G06F 16/29; G06F 9/5094

(57) ABSTRACT

The invention relates to a device for a vehicle, for externally transferring computing power, comprising: a computing unit for processing data, and a communications unit for transmitting data to an edge node and/or for receiving data from an edge node of an edge node network which comprises a plurality of stationary edge nodes and a plurality of mobile edge nodes, said computing unit being designed to transfer computing power, with the aid of the communications unit, to at least one of the stationary edge nodes and/or the mobile edge nodes of said edge node network.

### CROSS-REFERENCE TO RELATED APPLICATIONS

This application claims priority to German Patent Application No. DE 10 2018 009 903.3, filed on Dec. 20, 2018 with the German Patent and Trademark Office. The contents of the aforesaid Patent Application are incorporated herein for all purposes.

### TECHNICAL FIELD

The invention relates to a device for a vehicle for externally transferring computing power, an edge node network, and a method for providing an edge node network.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

Via so-called edge nodes, mobile edge computing can be used to also provide a mobile terminal with external computing resources located in the surroundings of the mobile terminal in addition to its own computing resources. If the mobile terminal is for example located in a vehicle and is moving along a route, a “hand-over” from one edge node to another edge node must occur when the mobile terminal leaves the catchment area of a first edge node and enters into the catchment area of a second edge node. In doing so, an interruption in the link to an edge node can occur from disturbances in the communication channel or from a lack of available edge nodes along the route, whereby the additional computing resources can suddenly disappear. Maps are known that reproduce a network coverage, or respectively a so-called quality of service for a region. If applicable, a prediction can also be made based on these maps about the availability of mobile edge computing. However, these are static maps that cannot bring about an active improvement of the occurring disturbances.

### SUMMARY

An object exists to provide an improved device for a vehicle to externally transfer computing power, an improved edge node network, and an improved method for providing an edge node network.

The object is solved by a device for a vehicle for externally transferring computing power, by an edge node network, and by a method for providing an edge node network having the features of the independent claims.

Embodiments of the invention are described in the dependent claims, the following description, and the drawings. Features that are disclosed in relation to the individual aspects/embodiments may be combined with one another.

### BRIEF DESCRIPTION OF THE DRAWING

FIG. 1 shows a schematic representation of an embodiment of a device within the scope of an edge node network having a plurality of stationary edge nodes and a plurality of mobile edge nodes.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description. In some embodiments, a device for a vehicle for externally transferring computing power is made available that can be operated reliably and with minimal interruption by means of outside computing power even when the vehicle is moving.

In some embodiments, an improved edge node network is provided in which the interruptions in the service can be reduced during the handover between the individual edge nodes on a route of the vehicle, in particular proactively. Furthermore, and in some embodiments, a method for providing an improved edge node network is provided.

A first exemplary aspect relates to a device for a vehicle for externally transferring computing power comprising: a computing unit for processing data, and a communications unit for transmitting data to an edge node and/or for receiving data from an edge node of an edge node network which comprises a plurality of stationary edge nodes and a plurality of mobile edge nodes, wherein the computing unit is designed to transfer computing power with the aid of the communications unit to at least one of the stationary edge nodes and/or the mobile edge nodes of the edge node network.

An edge node within the meaning of the present context may be understood to mean a computing node of an edge node network that has a processor with computing power, although limited in comparison to a base station of a mobile wireless carrier, and a communications unit for exchanging data with other edge nodes in an edge node network. The edge node may in other words be a computer that can serve as a portal for communication with other edge nodes of the edge node network for the purpose of exchanging data, and/or externally transferring computing power and/or sharing of computing resources, and/or sharing of computing results. The edge node may also be described as a gateway node or an edge node within the scope of an edge node network. Through the communications unit, the edge node may receive data from a terminal, such as the device according to the present aspect, that it can process with its own computing power on its processor. The edge node may send the results of the processing via the communications unit back to the terminal. The data may be sensor data that may be evaluated in the edge node. It is also conceivable that different computing tasks may be taken over by the edge node.

The device within the meaning of the present aspect may send data to an edge node of an edge node network that are to be processed in the edge node with the aid of additional computing power when, for example, the device's own computing power is unavailable, insufficient or is being otherwise used. In doing so, the edge node is selected from an edge node network that is located in the proximity, or respectively within the catchment area of the terminal. Accordingly, wait times may be avoided when there is a request to a central cloud, and the additional computing power may be provided on the periphery of the network in the proximity of the terminal. In this way, quicker and more efficient service for externally transferring computing power may be provided.

A mobile edge node within the meaning of the present teachings may be described as an edge node that may be moved. That is, the mobile edge node may be flexibly set up at locations where the computing power is needed. It is also conceivable that the mobile edge node may be moving while it provides the computing power. A vehicle such as a fleet vehicle, a drone or mobile base station may be used as a mobile edge node.

Stationary edge nodes are understood to be local edge nodes set up to be stationary, base stations of a network operator, and/or a mobile communications provider.

Within the scope of the present teachings, it is conceivable for the computing power that is externally transferred for an application to be externally transferred completely or just partially.

An underlying idea is that mobile edge nodes, particularly other vehicles, or also other mobile systems such as for example drones, are dynamically incorporated (i.e., flexibly in terms of time and/or place and/or performance) for externally transferring computing power when the device, i.e., a terminal, moves with a vehicle. The mobile edge nodes may be selected with reference to their probable route and/or speed. Along the route of the vehicle, appropriate edge nodes are selected from the mobile and/or stationary edge nodes so that the mobile device is always within a catchment area of at least one of these mobile and/or stationary edge nodes while it is moving. It is furthermore conceivable for the vehicle's own route to be divided into sections, and an appropriate edge node may be selected for each section from the edge node network having a plurality of stationary edge nodes and/or a plurality of mobile edge nodes. If the device is located in a parked vehicle, a stationary edge node of the edge node network may also be selected for externally transferring the computing power. When selecting the appropriate edge node(s) from the edge node network having a plurality of stationary edge nodes and/or a plurality of mobile edge nodes, current or forecast information on the edge nodes may be taken into account such as for example: the position, capacity utilization, catchment area, computing power, availability over time, available computing capacity, reliability and/or wait time. “Forecast information” means predictive information that will probably be available at the particular edge node when the vehicle on its route enters the catchment area of the particular edge node. The edge nodes and if applicable the information on the edge nodes may be depicted on a map. The map may depict the stationary and/or mobile edge nodes that lie and/or will probably lie on a route of the vehicle. According to some embodiments, an appropriate edge node is found along the route of the vehicle that may provide the computing power for the device on the particular section of the route. Therefore, additional computing power may be provided reliably and with minimal interruption even when the device is located in a moving vehicle. According to some embodiments, the device itself may log on as a mobile edge node in the edge node network in order to be able to completely or partially offer its own available computing power to other stations in the edge network. Moreover, mobile edge nodes may, e.g., be specifically providable as needed in areas of the network that have poor coverage by the edge nodes.

In some embodiments of the device for a vehicle for externally transferring computing power, a memory unit is provided in which a map (meaning a geographic map) is saved that may comprise at least one piece of current or forecast information on the stationary edge nodes and the mobile edge nodes of the edge node network. With the aid of such a memory unit, it may be made possible for the device to possess the information that may be decisive in the selection of the appropriate edge nodes for externally transferring computing power. With the aid of a map, the stationary edge nodes and the mobile edge nodes of the edge node network may be depicted that currently lie, and/or probably will lie, within a catchment area of the device, and/or along a route of the vehicle. In this way, the selection of appropriate stationary and/or mobile edge nodes may be made that may reliably make available to the device the computing power during the movement of the device with the vehicle. The information in this case may be the position, capacity utilization, catchment area, computing power, availability over time, available computing capacity, reliability and/or wait time of the stationary and/or mobile edge nodes. The map may moreover serve to determine the areas that have poor coverage by the edge nodes in order to circumvent these areas if desired.

Moreover, in a device for a vehicle for externally transferring computing power and in some embodiments, a map is saved in the memory unit which includes the stationary edge nodes and the mobile edge nodes of the edge node network within a catchment area of the device and/or along a route of the vehicle. The catchment area of the device may be determined by the range of the data communication that may be established by the communications unit of the device. The particular catchment area of the mobile and/or stationary edge nodes of the edge node network may be defined analogously, as well. In this way, it may be made possible for the map to only display those stationary and/or mobile edge nodes that may be relevant in terms of time and/or location to externally transfer computing power while the device is moving with the vehicle. At the same time, the available memory in the memory unit may accordingly only be used for relevant information. It is furthermore conceivable for the map to be able to depict the stationary and/or mobile edge nodes along the planned route of the vehicle that will probably be in the catchment area of the device on the route of the vehicle, or conversely, in the catchment area of which the device on the route of the vehicle will be. Beneficially, the information that relates to the mobile edge nodes may be displayed predictively for the time when the device enters their catchment area while it is moving with the vehicle. Moreover, the position of the mobile edge nodes along the planned route of the vehicle may be displayed proactively for the location on the route where the device enters their catchment area. In other words, the movement of the device and the mobile edge nodes along the planned route of the vehicle can be coordinated.

In some embodiments of the device for a vehicle for externally transferring computing power, the computing unit is designed to determine, depending on the at least one piece of information from the map, at least one of the stationary edge nodes and/or the mobile edge nodes of the edge node network to which computing power may be externally transferred. It is recognized in this context that, e.g., not just the mere presence of the device in the catchment area of an edge node may be relevant, but also the actual situation at the edge node that may be reflected with the aid of information on the edge node. If the device is in fact located in the proximity of an edge node but this edge node does not have sufficient computing capacity, no or insufficient computing power may be transferred externally. With the aid of information on the edge nodes, an intelligent selection of an appropriate edge node from the edge node network may be made in order to reliably externally transfer the desired computing power.

In some embodiments, the computing unit may be designed to externally transfer computing power, depending on the at least one piece of information from the map, with the aid of the communications unit to at least one of the stationary edge nodes, and/or the mobile edge nodes of the edge node network. Accordingly, an improved device may be provided that may reliably externally transfer computing power to appropriate edge nodes even when the vehicle in which the device is located, is moving.

In some embodiments, the map may include at least one of the following pieces of current or forecast information on the stationary edge nodes and on the mobile edge nodes of the edge node network:
position,
capacity utilization,
catchment area,
computing power,
availability over time,
available computing capacity,
reliability,
wait time.

With this information, areas are already known in advance in which it is only restricted or impossible to externally transfer the computing resources. This may correspondingly be planned by the vehicle and/or by the device when deciding when and/or along which route sections data and calculations are to be transferred externally to an edge node.

In some embodiments, the map may include at least one of the following pieces of current or forecast information on the mobile edge nodes of the edge node network:
probable route,
probable speed.

In other words, the map may also contain information that may be important to the mobile edge nodes, in addition to the information that may be equally specific to the stationary and/or mobile edge nodes. In addition, traffic and/or navigation information may also be important in order to be able to determine the presence and availability of mobile edge nodes, and/or predict this depending on the route of the vehicle.

In some embodiments, the map may display traffic and/or navigation information. Traffic and/or navigation information may help predictively determine the relative position of the device and the mobile edge nodes relative to each other.

In some embodiments, the computing unit may be designed to externally transfer the computing power for at least one of the following applications within the scope of a device for a vehicle for externally transferring computing power:
navigation,
streaming,
data processing,
gesture recognition,
evaluation of sensor data,
functions of driver assistance systems,
highly automated and/or autonomous driving.

Accordingly, the services may be improved and expanded in a beneficial manner within the scope of an edge node network. This may increase the customer's comfort.

Furthermore in a device for a vehicle for externally transferring computing power and in some embodiments, the computing unit is designed to update the map at regular intervals in time. It may therefore be ensured that as much current information as possible exists when the route is selected and/or when the appropriate edge nodes are selected.

In some embodiments, the computing unit is designed to log on and/or identify the device as a mobile edge node in the edge node network in order for the device to make available its own computing power to external network stations of the edge node network. In this way, the device can become an equal part of the edge node network. It is also conceivable that a reward system such as for example a points system may be provided for the mobile edge nodes, like the device according to the present aspect, that may make available its computing power to the other network stations.

In some embodiments, the communications unit may be designed to communicate an ID code of the device, and/or the device's own available computing power, to the edge node network. Accordingly, the device may be identified and may become part of the edge node network.

In some embodiments, the communications unit may be designed to establish a connection with the edge node network via WLAN/Wi-Fi and/or a mobile communications standard such as for example LTE or 5G. In this manner, flexible communication may be enabled within the edge node network.

In addition to the computing unit or within the scope of the computing unit, an identification unit may be provided in some embodiments in order to log on and/or identify the device as a mobile edge node with the edge node network. It is furthermore conceivable that the identification unit may be designed in the form of an ID transponder, a GPS transmitter or a SIM card. This may enable flexible compatibility of the device with different technologies and communication standards within the scope of the edge node network.

In some embodiments, the device may be designed in the form of a mobile terminal, a cell phone, a smart phone, a tablet computer, a navigation device, an instrument of an instrument panel, or a control unit of the vehicle. In this way, the device itself can be an edge node of the edge node network.

In some embodiments, the device may be able to be coupled to the vehicle functionally and/or in terms of information technology, and/or may be integratable in the vehicle. It is conceivable in this context that the computing unit of the device may be functionally connected to the vehicle. A functional connection may for example be to share parts of the telephone book, to synchronize the schedule, and to expand the functions of the vehicle with the functions of the device or vice versa. The communications unit for exchanging data with the other edge nodes may be a part of the device in this context. In addition, it is conceivable that the exchange of data with the other edge nodes may be carried out through a communications unit of the vehicle.

In a second exemplary aspect, an edge node network is provided, having: at least one stationary edge node and at least one mobile edge node, wherein the at least one mobile edge node is provided by a device that may be designed as described above. The same benefits that were described above in conjunction with the device are achieved by the edge node network. Reference is made to all of these benefits in the present case.

In some embodiments, at least one mobile edge node or another mobile edge node may be designed in the form of a mobile terminal, a cell phone, a smart phone, a tablet computer, a vehicle and/or a drone. Accordingly, an edge node network with expanded functions and improved connectivity may be made available in some embodiments.

In some embodiments, a central monitoring unit may be provided to monitor the edge node network, to control it, and/or to manage the computing power within the edge node system. In this way, a central coordination may be enabled within the edge node network.

In some embodiments, the central monitoring unit is designed to provide and/or update a map that includes at least one piece of information on the stationary edge nodes and on the mobile edge nodes of the edge node network. Since the central monitoring unit contains a wealth of information within the edge node network, the monitoring unit may provide an improved map that combines this information and makes it available for mobile applications, for example in vehicles. It is conceivable in this context that the device may request the part of the map of the monitoring unit that is relevant to it. It is moreover conceivable that the monitoring unit may send out the map to the network stations in regular sections.

In some embodiments, the central monitoring unit is designed to locate the stationary edge nodes and/or the mobile edge nodes of the edge node network. In this way, the monitoring unit may detect and organize the edge node network with its stations.

In some embodiments, the stationary edge nodes and the mobile edge nodes of the edge node network form a peer-to-peer system architecture (or a master-master system architecture) within the edge node network. In this way, the stationary and/or mobile edge nodes within the scope of the edge node network may organize independently and equally distribute monitoring and coordination functions among themselves.

In a third exemplary aspect, a method for providing an edge node network is provided, having: at least one stationary edge node and at least one mobile edge node, wherein the at least one mobile edge node is provided by a device that may be designed as described above. The same benefits that were described above in conjunction with the device according to the first aspect, and/or an edge node network according to the second aspect are achieved by the method according to the present aspect. Reference is made to all of these benefits in the present case.

In some embodiments, the method can include the following steps:
evaluate a map that includes at least one piece of current or forecast information on the at least one stationary edge node and on the at least one mobile edge node of the edge node network,
determine at least one zone with reduced computing capacity,
provide at least one mobile edge node in the determined zone with the reduced computing capacity.

Therefore, a dynamic edge node network may be provided that may effectively prevent the sudden deterioration of the edge node coverage.

Beneficially, the method may be designed to provide an edge node network that may be designed as described above.

Reference will now be made to the drawings in which the various elements of embodiments will be given numerical designations and in which further embodiments will be discussed.

In the exemplary embodiments, the described components of the embodiments each represent individual features that are to be considered independent of one another, in the combination as shown or described, and in combinations other than shown or described.

Specific references to components, process steps, and other elements are not intended to be limiting. Further, it is understood that like parts bear the same or similar reference numerals when referring to alternate FIGS. It is further noted that the FIGS. are schematic and provided for guidance to the skilled reader and are not necessarily drawn to scale. Rather, the various drawing scales, aspect ratios, and numbers of components shown in the FIGS. may be purposely distorted to make certain features or relationships easier to understand.

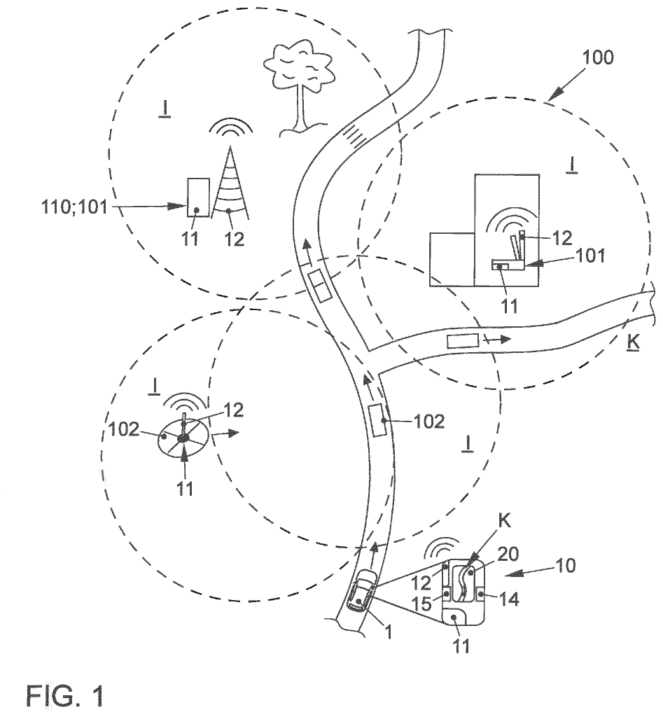

FIG. 1 shows a device 10 for a vehicle 1 for externally transferring computing power that is located in the vehicle 1 while the vehicle 1 is moving. The device 10 has a computing unit 11 for processing data and a communications unit 12 for transmitting data to an edge node 101, 102, and/or for receiving data from an edge node 101, 102, of an edge node network 100 which can comprise a plurality of stationary edge nodes 101 and a plurality of mobile edge nodes 102. The computing unit 11 is designed to externally transfer computing power with aid of the communications unit 12 to at least one of the stationary edge nodes 101 and/or the mobile edge nodes 102 of the edge node network 100. This can mean the computing power that is entirely or partially needed for a desired application on the device 10.

An edge node 101, 102 can be understood to be a computing node of an edge node network 100 that also has a computing unit 11 such as for example a processor for providing computing power, and a communications unit 12 for exchanging data with terminals and/or other edge nodes 101, 102 of the edge node network 100. In principle, an edge node 101, 102 can be provided by a computer, for example with a Wi-Fi/WLAN connection. It is also conceivable that a stationary edge node 101 may be provided by a base station of a mobile communications provider and/or a network operator.

The device 10 m send data to an edge node 101, 102 of an edge node network 100 in order to process the data there when for example its own computing power is unavailable, or is insufficient, or is otherwise used. Within the scope of the present discussion, it is conceivable for the computing power for at least one desired application to be externally transferred completely or just partially.

The edge node network 100 can have mobile edge nodes 102 in addition to stationary edge nodes 101. The mobile edge nodes 102 may be moved. It is conceivable in this context that the mobile edge nodes 102 may be set up flexibly at locations where the computing resources are needed, for example in zones with limited coverage by the edge nodes 101, 102. It is also conceivable that the mobile edge nodes 102 may be moving while they provide the computing power to other stations of the edge node network 100. Vehicles such as fleet vehicles or drones may arise as mobile edge nodes 102. The fleet vehicles and/or drones can be specifically routed to the roads with a high traffic volume in order to be able to satisfy a strong demand there for computing resources. It is moreover conceivable that such mobile edge nodes 102 can be specifically routed to areas with poor coverage where the coverage with the edge nodes 101, 102 is not or is insufficiently met.

The mobile edge nodes 102 of the edge node network 100 such as for example other vehicles or also other mobile systems, such as for example drones, are taken into account while externally transferring computing power. That is, the mobile edge nodes 102 of the edge node network 100 are dynamically (i.e., flexibly in terms of time and/or place) incorporated while distributing the computing resources. The mobile edge nodes 102 can be selected based on their probable route and/or speed. In FIG. 1, other vehicles are shown for example as mobile edge nodes 102. A drone is also shown in FIG. 1 as a possible edge node 102.

While the device 10 is moving with the vehicle 1, appropriate edge nodes 101, 102 are selected from the mobile and/or stationary edge nodes 101, 102 of the edge node network 100 along the route of the vehicle 1 so that the mobile device 10 is always within a catchment area of at least one of these mobile and stationary edge nodes 101, 102 while it is moving. The catchment areas of the mobile and/or stationary edge nodes 101, 102 are shown with dashed lines in FIG. 1. The route of the vehicle 1 may for example be divided into sections, and an appropriate edge node 101, 102 can be selected for each section from the edge node network 100 so that the additional computing resources can be provided without interruption to the device 10. If the device 10 is located in a parking vehicle 1, a stationary edge node 101 of the edge node network 100 can also be sufficient for externally transferring the computing power.

When selecting the appropriate edge node(s) 101, 102 from the edge node network 100, current or forecast information I about the edge nodes 101, 102 can be taken into account such as for example:
position,
capacity utilization,
catchment area,
computing power,
availability over time,
available computing capacity,
reliability and/or
wait time.

As already mentioned above, the map K can comprise one of the following current or forecast pieces of information I on the mobile edge nodes 102 of the edge node network 100, such as for example:
probable route,
probable speed.

“Forecast information” I means predictive information I that will probably be available at the particular edge node 101, 102 when the vehicle 1 on its route enters the catchment area of the particular edge node 101, 102.

The stationary and/or mobile edge nodes 101, 102 and if applicable the information I on the edge nodes 101, 102, can be depicted on a map K. The map K can for example be displayed on a display 20 of the device 10, or on a display in a dashboard of the vehicle 1.

The map K can especially depict the edge nodes 101, 102 that lie and/or will probably lie along the selected route of the vehicle 1. The edge nodes 101, 102 can in this context be selected so that, while the device 10 is moving with the vehicle 1, an edge node 101, 102 is always located in the catchment area of the device 10, or in other words, the device 10 is always located in a catchment area of one of the selected edge nodes 101, 102. This makes it possible for the additional computing power to be provided reliably and with minimal interruption while the device 10 is moving with the vehicle 1.

According to another exemplary aspect, the device 10 itself may log on as a mobile edge node 102 within the scope of the edge node network 100 in order to be able to offer its own computing power, that is entirely or partially available, to other stations in the edge network 100.

According to yet another aspect, a method for providing the edge node network 100 may provide that mobile edge nodes 102 are specifically provided as needed in areas of the edge node network 100 that have poor coverage by the edge nodes 101, 102.

The computing power that can be externally transferred by the device 10 can be needed for at least one of the following applications such as for example:
navigation,
streaming,
data processing,
gesture recognition,
evaluation of sensor data,
functions of driver assistance systems,
highly automated and/or autonomous driving.

The computing unit 11 within the scope of the device 10 may be designed to update the map K at regular intervals in time in order to make available the most current information when selecting the route and/or when selecting the appropriate edge nodes 101, 102.

As already mentioned above, the device 10 itself can function as a mobile edge node 102. To accomplish this, the computing unit 11 of the device 10 can be designed to log on and/or identify the device 10 as a mobile edge node 102 with the edge node network 100. The communications unit 12 can in this context transmit corresponding data to the edge node network 100 such as for example an ID code of the device 10 and/or the device's 10 own available computing power. The communications unit 12 can establish a connection with the edge node network 100, for example via WLAN and/or a mobile communications standard (LTE, 5G).

In addition to the computing unit 11 or within the scope of the computing unit 11, an identification unit 15 can be provided in order to log on and/or identify the device 10 as a mobile edge node 102 with the edge node network 100. It is conceivable in this context that the identification unit 15 can be designed in the form of an ID transponder, a GPS transmitter or a SIM card.

It is furthermore conceivable that the device 10 may be able to be coupled to the vehicle 1 functionally and/or in terms of information technology, and/or can be integratable in the vehicle 1. A functional connection may for example exist to share and/or to expand the functions of the vehicle 1 with the functions of the device 10 or vice versa. The communications unit 12 for exchanging data with the other edge nodes 101, 102 can be a part of the device 10. In addition, it is conceivable that the exchanging of data with the other edge nodes 101, 102 can be carried out through a communications unit 12 of the vehicle 1.

Within the scope of the edge node network 100, a central monitoring unit 110 can be provided to monitor the edge node network 100, to control it, and/or to manage the computing power within the edge node network 100. This central monitoring unit 110 can be designed to provide and/or update a map K for the edge node network 100 that includes at least one piece of the aforementioned information I on the stationary edge nodes 101 and on the mobile edge nodes 102 of the edge node network 100. A part of this map K that can be relevant for the route of the vehicle 1 can be transmitted to the device 10 automatically or upon request.

Beneficially, the central monitoring unit 110 can be designed to locate the stationary edge nodes 101 and/or the mobile edge nodes 102 of the edge node network 100. Accordingly, a comprehensive picture of existing stationary edge nodes 101 and/or mobile edge nodes 102 within the edge node network 100 can be created.

Alternatively or in addition, it can be provided in the edge node network 100 that the stationary edge nodes 101 and the mobile edge nodes 102 of the edge node network 100 form an equal peer-to-peer system architecture (or a master-master system architecture) within the edge node network 100 in order to organize themselves and equally share monitoring and coordination functions with each other.

The description of the FIGS. given in the preceding describes the present invention exclusively within the scope of examples. Of course, individual features of the embodiments may be combined freely with one another, to the extent that this is technically feasible, without departing from the scope of the invention.

### LIST OF REFERENCE NUMERALS

1 Vehicle

10 Device

11 Computing unit

12 Communications unit

14 Memory unit

15 Identification unit

20 Display

100 Edge node network

101 Stationary edge node

102 Mobile edge node

110 Monitoring unit

K Map

I Information

The invention has been described in the preceding using various exemplary embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments.

The mere fact that certain measures are recited in mutually different dependent claims or embodiments does not indicate that a combination of these measures cannot be used to advantage. Any reference signs in the claims should not be construed as limiting the scope.

What is claimed is:

1. A device for a vehicle for externally transferring computing power, comprising:
a processor for processing data; and
a communications interface for transmitting data to an edge node and/or for receiving data from an edge node of an edge node network which comprises a plurality of stationary edge nodes and a plurality of mobile edge nodes;
wherein the processor is configured to externally transfer computing power with the aid of the communications interface to at least one of the stationary edge nodes and/or the mobile edge nodes of the edge node network.

2. The device of claim 1, wherein a memory is provided in which a map is saved that comprises current or forecast information on the stationary edge nodes and the mobile edge nodes of the edge node network;
and/or a map is saved in the memory that comprises the stationary edge nodes and the mobile edge nodes of the edge node network within a catchment area of the device and/or along a route of the vehicle.

3. The device of claim 2, wherein the processor is configured to determine, depending on the information from the map, at least one of the stationary edge nodes and/or the mobile edge nodes of the edge node network to which computing power can be externally transferred;
and/or in that the processor is configured to externally transfer computing power, depending on the information from the map, with the aid of the communications interface to at least one of the stationary edge nodes and/or the mobile edge nodes of the edge node network.

4. The device of claim 2, wherein the map comprises at least the following current or forecast information on the stationary edge nodes and the mobile edge nodes of the edge node network:
position,
capacity utilization,
catchment area,
computing power,
availability over time,
available computing capacity,
reliability,
wait time.

5. The device of claimi 2, wherein the map comprises at least one of the following current or forecast information on the mobile edge nodes of the edge node network:
probable route,
probable speed.

6. The device of claim 1, wherein the processor is configured to externally transfer the computing power for at least one of the following applications:
navigation,
streaming,
data processing,
gesture recognition,
evaluation of sensor data,
functions of driver assistance systems,
highly automated and/or autonomous driving.

7. The device of claim 2, wherein the processor is configured to update the map at regular intervals in time.

8. The device of claim 1, wherein the processor is configured to log on and/or identify the device as a mobile edge node with the edge node network in order for the device to make available its own computing power to external network stations of the edge node network.

9. The device of claim 1, wherein the communications interface is configured to communicate an ID code of the device and/or the device's own available computing power to the edge node network
and/or in that the communications interface is configured to establish a connection with the edge node network via Wi-Fi and/or a mobile communications standard.

10. The device of claiim 1, wherein an identification circuit is provided to log on and/or identify the device as a mobile edge node with the edge node network,
and/or in that the identification circuit is configured in the form of an ID transponder, a GPS a transmitter, or a SIM card.

11. The device of claim 1, wherein the device is configured in the form of a mobile terminal, a cell phone, a smart phone, a tablet computer, a navigation device, an instrument of an instrument panel, or a control unit of the vehicle
and/or in that the device can be coupled to the vehicle functionally and/or in terms of information technology, and/or is integratable in the vehicle.

12. An edge node network having:
at least one stationary edge node and
at least one mobile edge node,
wherein the at least one mobile edge node is provided by the device of claim 1.

13. The edge node network of claim 12, wherein the at least one mobile edge node or another mobile edge node of the edge node network is configured in the form of a mobile terminal, a cell phone, a smart phone, a tablet computer, a vehicle and/or a drone.

14. The edge node network of claim 12, wherein a central monitoring circuit is provided to monitor the edge node network, to control it, and/or to manage the computing power within the edge node network.

15. The edge node network of claim 14, wherein the central monitoring circuit is configured to provide and/or update a map that includes at least information on the stationary edge nodes, and on the mobile edge nodes of the edge node network,
and/or in that the central monitoring circuit is configured to locate the stationary edge nodes and/or the mobile edge nodes of the edge node network.

16. The edge node network of claim 12, wherein the stationary edge nodes and the mobile edge nodes of the edge node network form a peer-to-peer system architecture within the edge node network.

17. A method for providing an edge node network having:
at least one stationary edge node and
at least one mobile edge node,
wherein the at least one mobile edge node is provided by the device of claim 1.

18. The method of claim17, wherein the method comprises the following steps:
evaluating a map that includes at least current or forecast information on the at least one stationary edge node and on the at least one mobile edge node of the edge node network;
determining at least one zone with reduced computing capacity,
providing at least one mobile edge node in the determined zone with the reduced computing capacity.

19. The method of claim 17, wherein the method for providing an edge node network is executed according to claim 12.

20. The device of claim 3, wherein the map comprises at least the following current or forecast information on the stationary edge nodes and the mobile edge nodes of the edge node network:
position,
capacity utilization,
catchment area,
computing power,
availability over time,
available computing capacity,
reliability,
wait time.
